(19) United States
(12) Patent Application Publication
(10) Pub. No.: US 2008/0018680 A1
(43) Pub. Date: Jan. 24, 2008

(54) Print apparatus and print method

(75) Inventors: Tatsumi Ito, Tokyo (JP); Makoto Ando, Tokyo (JP); Koji Ashizaki, Tokyo (JP); Takahiro Toyoda, Tokyo (JP); Minoru Takeda, Tokyo (JP); Seiji Kobayashi, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/879,895

(22) Filed: Jul. 19, 2007

(30) Foreign Application Priority Data
Jul. 21, 2006 (JP) JP2006-199942

(51) Int. Cl. B41J 29/38

(52) U.S. Cl. 347/9

(57) ABSTRACT

Disclosed is a print apparatus that includes a disc rotating unit rotating a disc-shaped recording medium detachably mounted thereon, an optical pickup performing recording and/or reproduction of an information signal on an information recording surface of the disc-shaped recording medium, a print head printing visible information by ejecting ink droplets onto a label surface of the rotated disc-shaped recording medium, and a head control unit controlling ejection timing of the ink droplets ejected by ejection nozzles. In the print apparatus, the head control unit controls so that part of the visible information to be printed that corresponds to one revolution of the disc-shaped recording medium is printed by applying ink droplets at certain positions with certain interval apart in a circumferential direction during a first revolution of the disc-shaped recording medium and applying ink droplets to a part left by the first revolution during at least a second revolution.

### CROSS REFERENCES TO RELATED APPLICATIONS

The present invention contains subject matter related to Japanese Patent Application JP 2006-199942 filed in the Japanese Patent Office on Jul. 21, 2006, the entire contents of which being incorporated herein by reference.

### BACKGROUND OF THE INVENTION

1. Field of the Invention

The present invention relates to a print apparatus and a print method that rotate a disc-shaped recording medium, such as a CD-R (Compact Disc-Recordable) or a DVD-RW (Digital Versatile Disc-Rewritable), a semiconductor storage medium, or other printed object and print visible information such as characters and designs by ejecting ink droplets onto a label surface or other print surface of the rotating printed object.

2. Description of the Related Art

One example of this type of print apparatus is disclosed by Japanese Unexamined Patent Application Publication No. H09-265760. Japanese Unexamined Patent Application Publication No. H09-265760 relates to an optical disc apparatus that is capable of printing on a removable optical disc. The optical disc apparatus disclosed in Japanese Unexamined Patent Application disclosed in Japanese Unexamined Patent Application Publication No. H09-265760 is characterized by being an information storage apparatus that can carry out at least one of the recording and the reproduction of information using a removable optical disc and includes: a print head that prints on the optical disc; a print head driver that moves the print head in the radial direction of the optical disc; a spindle motor that rotates the optical disc; and a control unit that controls the print head, the print head driver, and the spindle motor, where the control unit causes the print head to scan across the optical disc to print on the optical disc.

The optical disc apparatus including disclosed in Japanese Unexamined Patent Application Publication No. H09-265760 demonstrates such an effect of printing a label on an optical disc without having to separately provide a dedicated label printer and with the disc still inserted in the optical disc apparatus (see Paragraph [0059]).

The optical disc apparatus disclosed by Japanese Unexamined Patent Application Publication No. H09-265760 is constructed so as to print visible information by ejecting ink droplets onto the label surface of an optical disc that is being rotated at high speed by a spindle motor. However, the apparatus will have more potential in industry if the ejection frequency for the ink droplets can be set at a suitable ejection frequency for an optical disc that is being rotated at high speed.

One possibility for setting the ejection frequency at the suitable ejection frequency may be to have the spindle motor rotate at low speed to lower the required ejection frequency to a value that can actually be set. However, if a spindle motor is rotated at low speed, the rotation of the spindle motor will not stabilize. As a result, the optical disc may not rotate stably and hence favorable print quality may not be obtained.

Generally, in view of temperature rises for a print head, ink refilling, meniscus stability, and the like, the ejection frequency of an ink jet-type print head is set at around 10 KHz for a bubble jet head® type head. For example, if the distance from the center of an ink droplet dripped onto the outermost periphery of the printable region to the center of rotation of the optical disc is 60 mm and the gap between ink droplets dripped onto the outermost periphery is 42.3 μm (corresponding to 600 dpi), the number of revolutions per minute (rpm) of the optical disc (or the spindle motor) is calculated as shown below.
linear velocity: 42.3 μm[m]×10×10³ [1/s]=0.423 [m/s]
disc rpm: 0.423 [m/s]/(120×10⁻³×π)×60 [s]=67.3 [rpm]

However, since it is difficult for the spindle motor used by a typical optical disc apparatus to rotate stably at 100 rpm or below, favorable print quality may not be obtained.

This situation relates to the fact that the standard linear velocities used during the recording and/or reproduction of an optical disc are respectively set for each type of optical disc. For example, the linear velocity is set at 1.2 to 1.4 m/s for a compact disc (CD), at 3.49 m/s for a DVD, and at 4.55 m/s for a Blu-Ray Disc®. This implies that the rotational velocity during recording and/or reproduction for each of the above types of optical disc is 200 rpm or above, so that there has been no demand for spindle motors with a rotational velocity of 100 rpm or below.

In addition, further development of optical disc drive technology in recent years has resulted in optical disc apparatuses now carrying out recording and/or reproduction at several times to several tens of times the standard linear velocity (as examples, at double-speed, eight-speed, or even twenty-four-speed measured relative to the standard linear velocity). This implies that there is demand for spindle motors to operate at higher rotational velocities. However, to realize a spindle motor capable of both high rotational velocities such as these and also a low rotational velocity such as the 67.3 rpm described earlier, there may be both technical difficulties and a higher manufacturing cost to which some countermeasures may be provided.

### SUMMARY OF THE INVENTION

According to embodiments of the present invention, a suitable ejection frequency of ink droplets may be set for an optical disc rotated at high speed. According to embodiments of the present invention, favorable print quality can also be obtained since the rotation of the spindle motor may not fail to stabilize when the spindle motor rotates at low speed to rotate the optical disc at low speed corresponding to a predetermined ejection frequency.

A print apparatus according to an embodiment of the present invention includes: a disc rotating unit that rotates a disc-shaped recording medium detachably mounted thereon; an optical pickup that carries out recording and/or reproduction of an information signal on an information recording surface of the disc-shaped recording medium rotated by the disc rotating unit; a print head that prints visible information by ejecting ink droplets onto a label surface of the rotated disc-shaped recording medium; and a head control unit that controls ejection timing of the ink droplets ejected by ejection nozzles provided on the print head. The head control unit carries out control so that a part of the visible information to be printed that corresponds to one revolution of the disc-shaped recording medium is printed by applying ink droplets at a plurality of positions a predetermined interval apart in a circumferential direction during a first revolution of the disc-shaped recording medium and applying ink droplets to a part left by the first revolution during at least a second revolution.

According to an embodiment of the present invention, it is possible to carry out printing by ejecting ink droplets according to a predetermined ejection frequency on the label surface of a disc-shaped recording medium that is being stably rotated.

### BRIEF DESCRIPTION OF THE DRAWINGS

FIG. 1 is a plan view of an optical disc apparatus that is a first embodiment of a print apparatus according to the present invention;

FIG. 2 is a front view of the optical disc apparatus that is the first embodiment of a print apparatus according to the present invention;

FIG. 3 is a block diagram showing the flow of signals in the optical disc apparatus that is the first embodiment of a print apparatus according to the present invention;

FIG. 4 is a flowchart showing the flow of operations by a control unit of the print apparatus according to an embodiment of the present invention and is useful in explaining a process that generates ink ejection data based on visible information;

FIGS. 5A to 5C are diagrams useful in explaining a process with which the print apparatus according to an embodiment of the present invention converts biaxial perpendicular coordinate data to polar coordinate data;

FIG. 6 is a diagram useful in explaining an approximate calculation of correction weightings by the print apparatus according to an embodiment of the present invention;

FIGS. 7A to 7F are diagrams useful in explaining a process that generates the ink ejection data from the polar coordinate data according to the first embodiment of a print apparatus of the present invention;

FIGS. 8A to 8J are diagrams useful in explaining a calculation process of an error diffusion method used when generating ink ejection data from dot correction data according to the first embodiment of the print apparatus of the present invention;

FIGS. 9A to 9C are diagrams useful in explaining how ink ejection data is divided by the print apparatus according to an embodiment of the present invention, with FIG. 9A showing first divided data, FIG. 9B showing second divided data, and FIG. 9C showing third divided data;

FIG. 10 is a diagram useful in explaining positions on the label surface of an optical disc that correspond to dots of the first divided data;

FIG. 11A and FIG. 11B are diagrams useful in explaining first revolution first divided data and second revolution first divided data of the first divided data shown in FIGS. 9A to 9C, with FIG. 11A showing positions on the label surface of the optical disc that correspond to dots in the first revolution first divided data and FIG. 11B showing positions on the label surface of the optical disc that correspond to dots in the second revolution first divided data; and

FIG. 12 is a diagram useful in explaining a second specific example of the first revolution first divided data.

### DESCRIPTION OF THE PREFERRED EMBODIMENTS

A print apparatus and a print method that can carry out printing by ejecting ink droplets at a predetermined ejection frequency while stably rotating a disc-shaped recording medium are realized by a simple construction by ejecting ink droplets at a predetermined ejection frequency from a print head so that ink droplets are dripped at predetermined intervals in the circumferential direction during a first revolution of a disc-shaped recording medium and ink droplets are dripped at parts left by the first revolution during at least a second revolution.

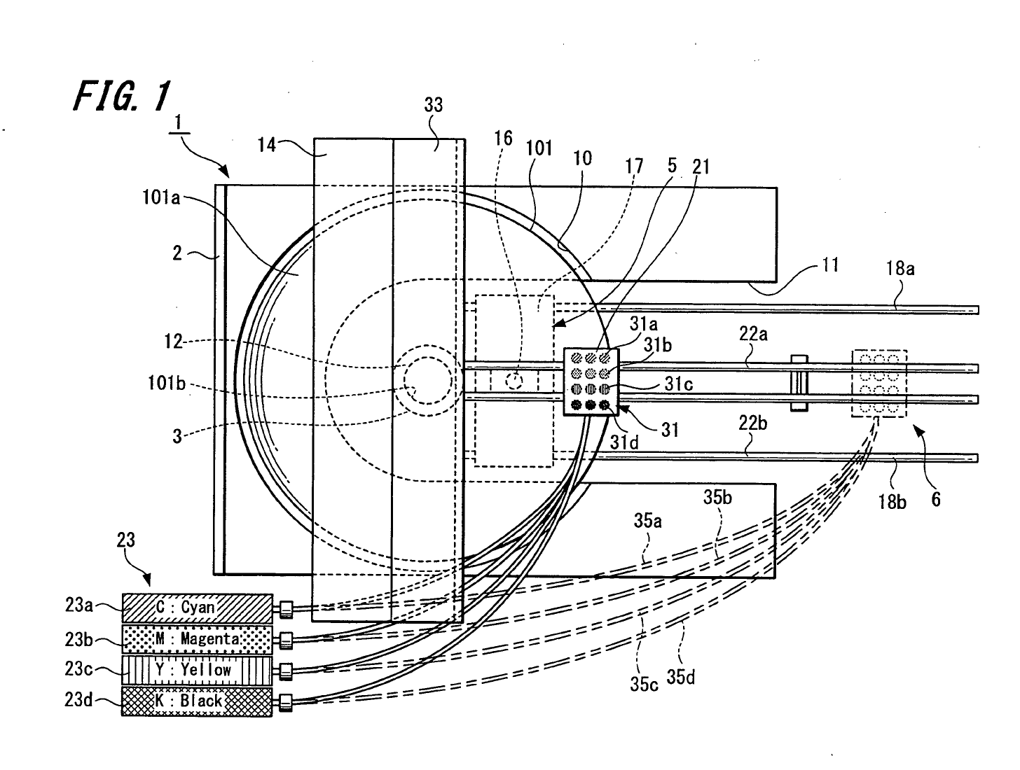

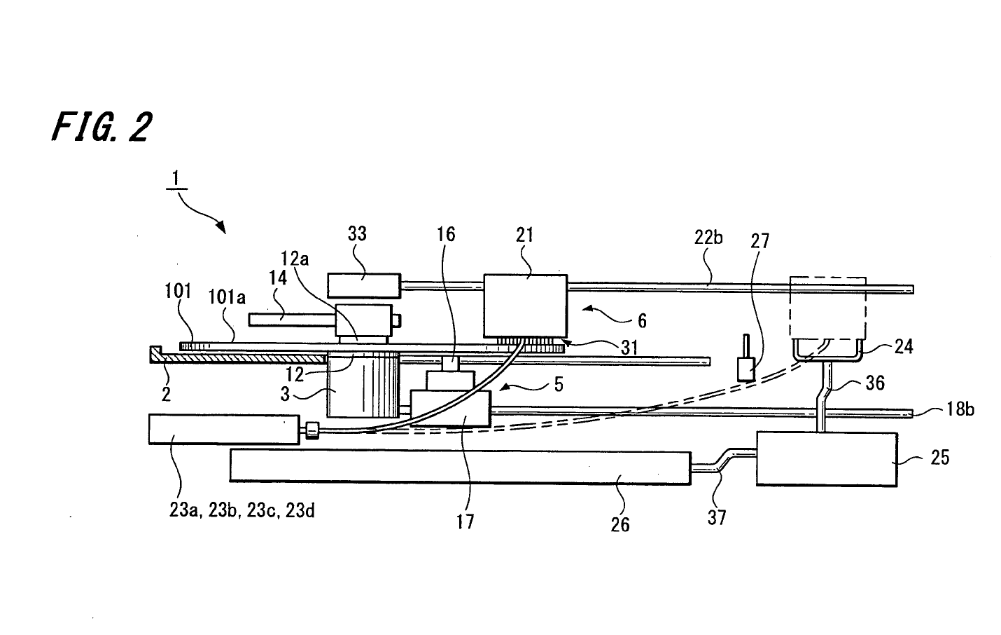

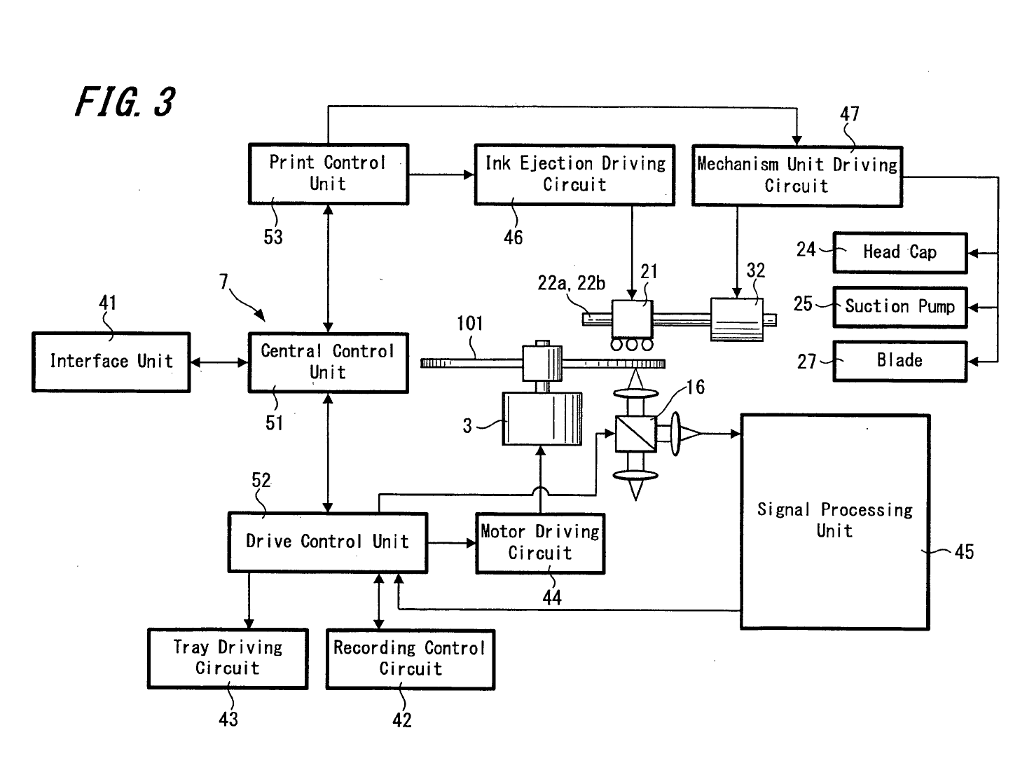

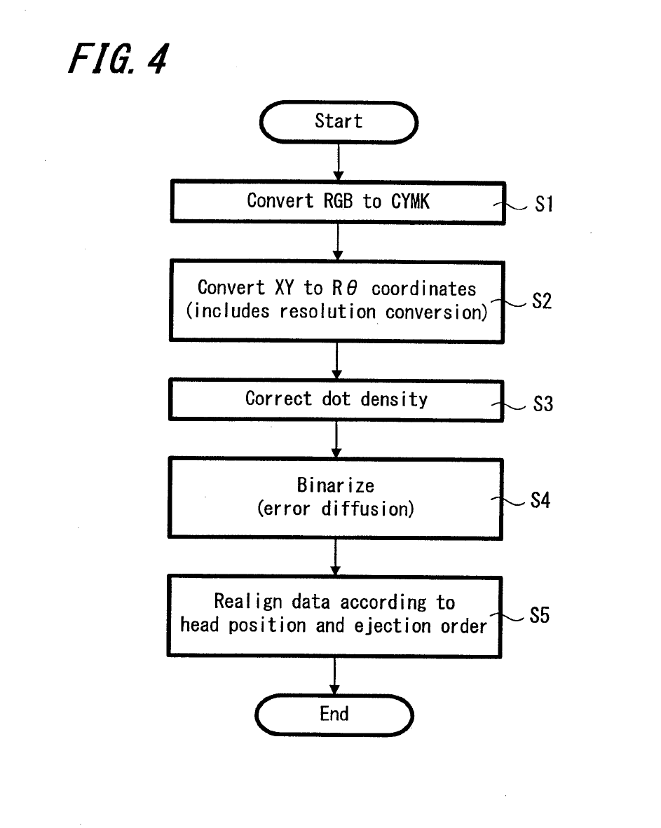

FIGS. 1 to 12 are useful in explaining one embodiment of the present invention. FIG. 1 is a plan view showing a first embodiment of a print apparatus according to the present invention, FIG. 2 is a front view of the same, FIG. 3 is a block diagram showing the flow of signals in the print apparatus shown in FIG. 1, and FIG. 4 is a flowchart showing the flow of operations by a control unit.

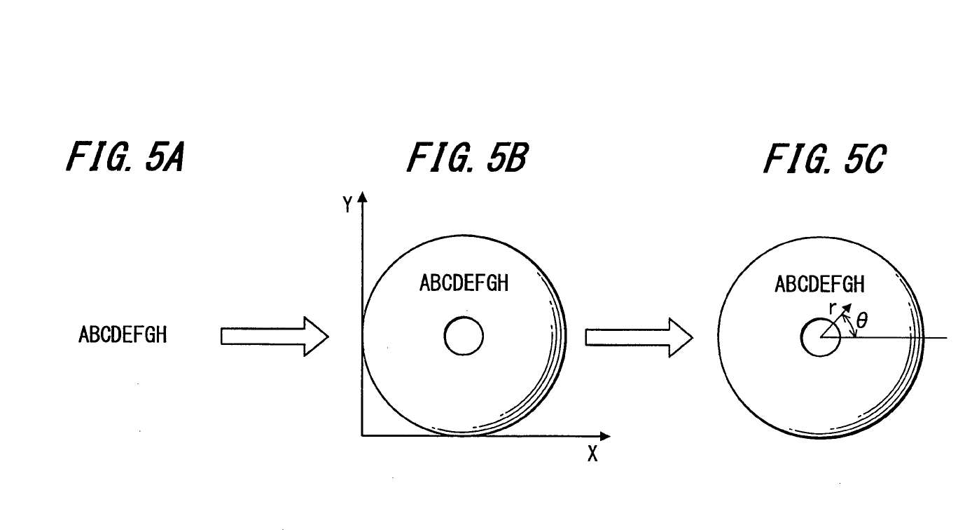

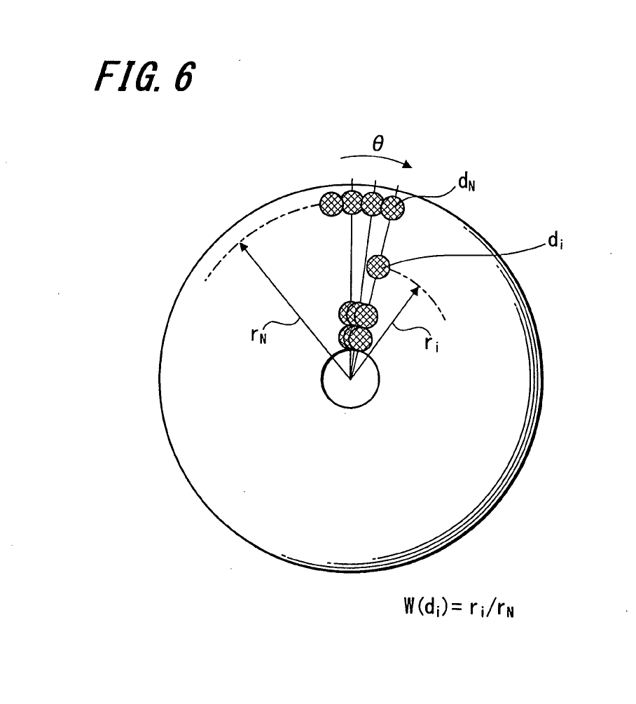

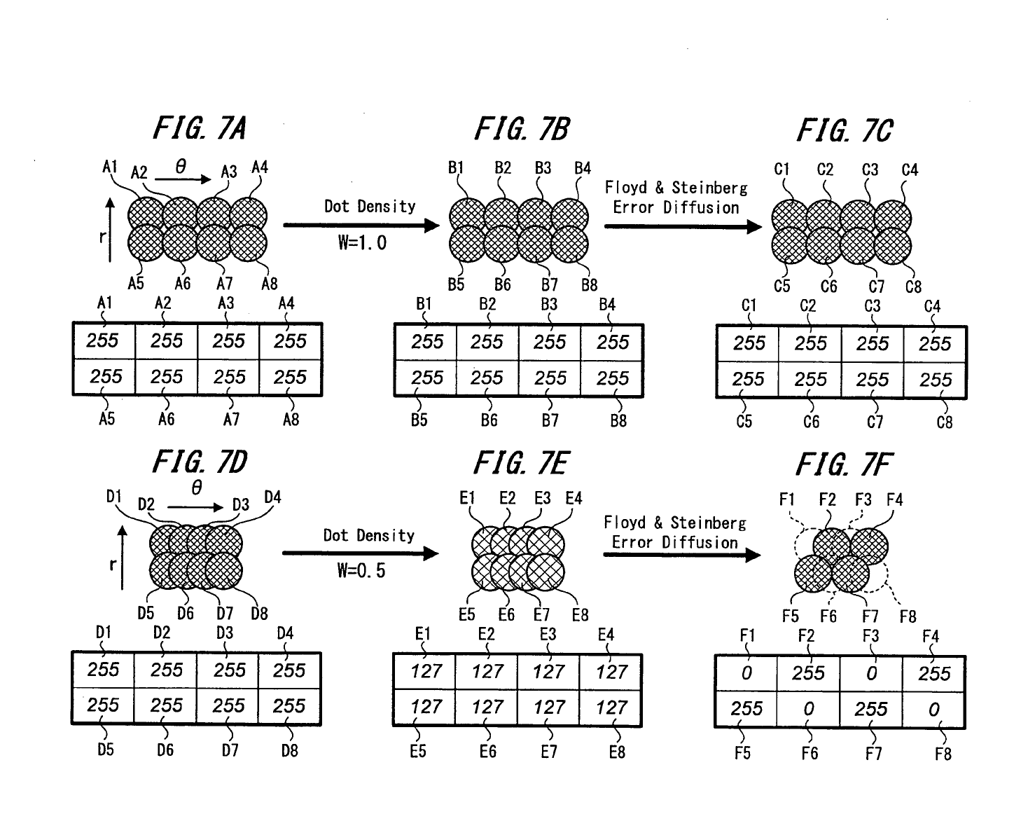

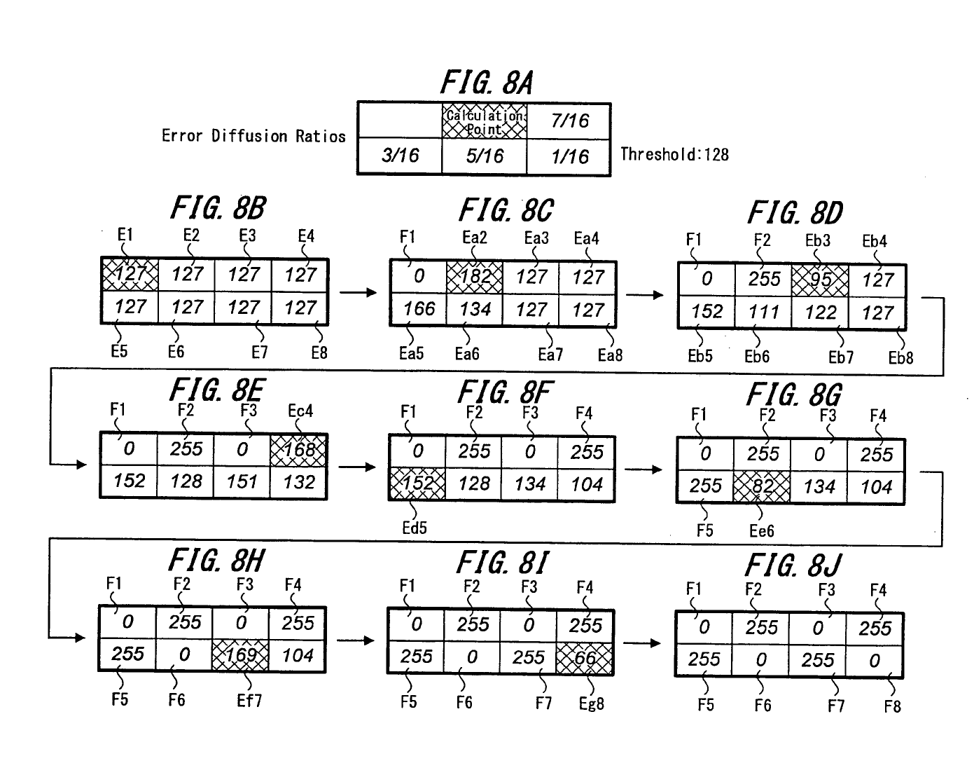

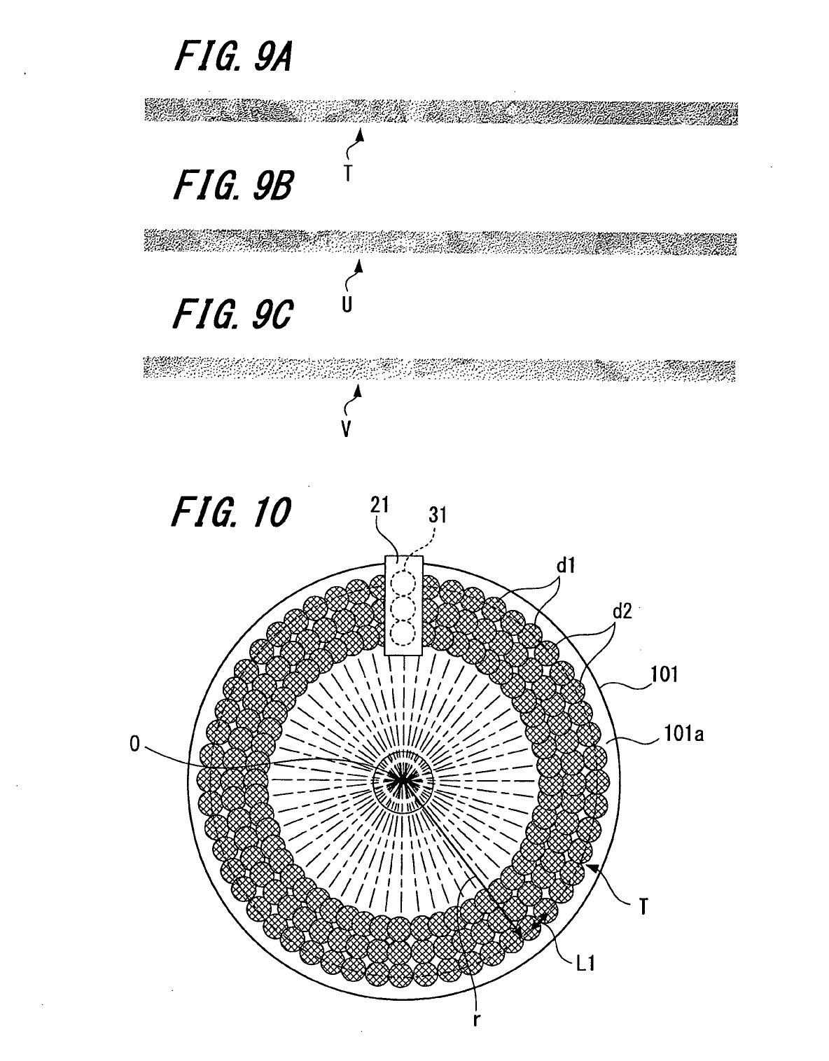

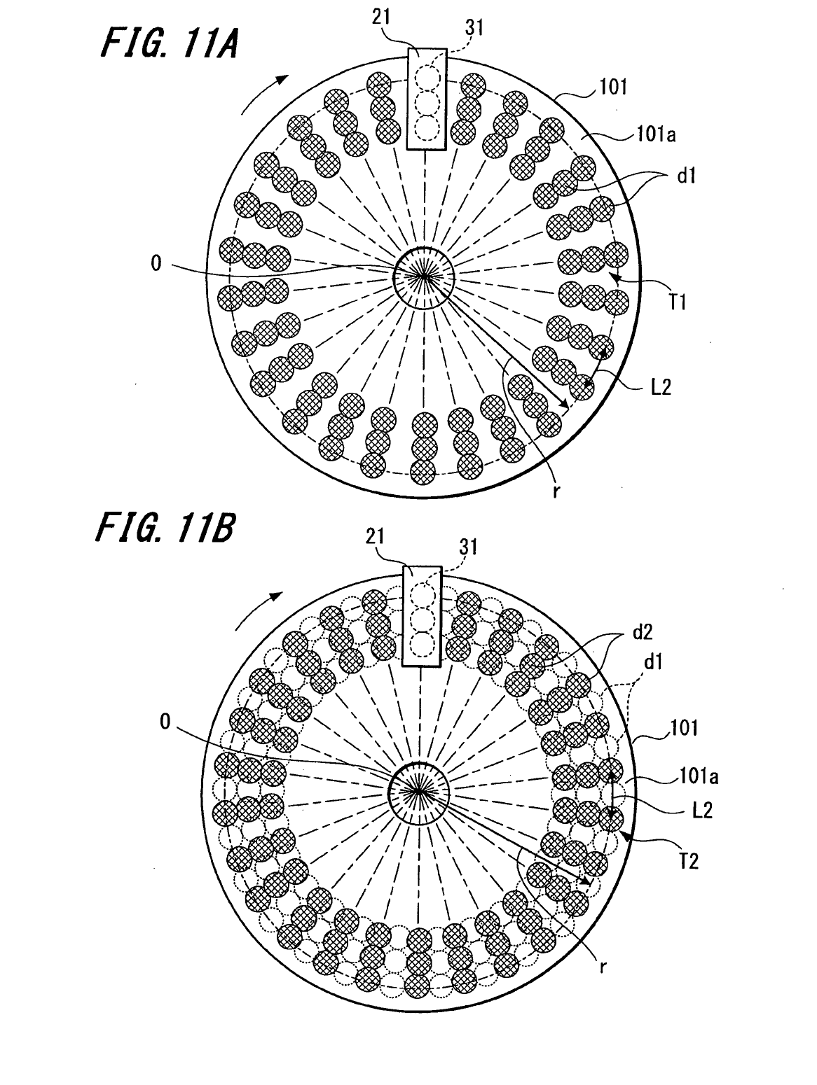

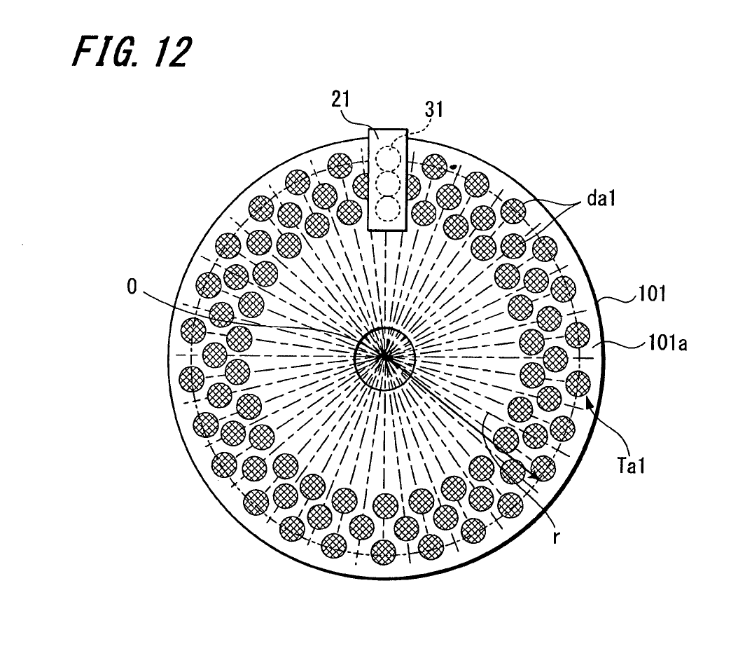

FIGS. 5A to 5C are diagrams useful in explaining a process that converts perpendicular biaxial coordinate data to polar coordinate data, FIG. 6 is a diagram useful in explaining correction weightings for dot density correction, FIGS. 7A to 7F are diagrams useful in explaining the process as far as generation of the ink ejection data, and FIGS. 8A to 8J are diagrams useful in explaining the calculation process of the error diffusion method. FIGS. 9A to 9C are diagrams useful in explaining first to third divided data of the ink ejection data, FIG. 10 is a diagram useful in explaining positions on the label surface that correspond to dots of the first divided data, FIGS. 11A and 11B are diagrams useful in explaining first revolution first divided data and second revolution first divided data of the first divided data, and FIG. 12 is a diagram useful in explaining a second specific example of the first revolution first divided data.

FIG. 1 and FIG. 2 show an optical disc apparatus 1 that is a first embodiment of a print apparatus according to the present invention. The optical disc apparatus 1 is capable of recording (writing) a new data signal onto and/or reproducing (reading) a data signal that has been recorded from an information recording surface of an optical disc 101, such as a CD-R or DVD-RW, as a specific example of a “printed object”, and is also capable of printing visible information, such as characters and designs, on a label surface (main surface) 101a of the optical disc 101 that is a specific example of a “print surface”.

As shown in FIGS. 1 to 3, the optical disc apparatus 1 includes a tray 2 that conveys the optical disc 101, a spindle motor 3 that is a specific example of a “disc rotating unit” for rotating the optical disc 101 that has been conveyed by the tray 2, a recording and/or reproducing unit 5 including an optical pickup 16 that writes and/or reads information onto or from the information recording surface of the optical disc 101 rotated by the spindle motor 3, a print unit 6 including a print head 21 that prints visible information such as characters and images on the label surface 101a of the rotated optical disc 101, and a control unit 7 that controls the optical pickup 16, the print head 21, and the like.

The tray 2 of the optical disc apparatus 1 includes a plate-shaped member that is rectangular in planar form and slightly larger than the optical disc 101. A disc holding portion 10 having a circular concave portion for holding the optical disc 101 is provided in an upper surface that is one of the large flat surfaces of the tray 2. The tray 2 is also provided with a cutaway portion 11 to avoid contact with the spindle motor 3 and the like. The cutaway portion 11 is formed in a wide shape from one of the shorter edges of the tray 2 to a central part of the disc holding portion 10. The tray 2 is selectively conveyed to one of a disc attachment position where the optical disc 101 is attached to a disc attachment portion of the spindle motor 3 and a disc eject position which is located outside the apparatus housing and to which the tray 2 is discharged with the optical disc 101 mounted thereupon.

The spindle motor 3 is disposed on a motor base (not shown) so as to be positioned at a substantially central part of the disc holding portion 10 when the tray 2 has been conveyed to the disc attachment position. A turntable 12 including a disc engagement portion 12a that detachably engages a center hole 101b of the optical disc 101 is provided at a front tip of the rotational shaft of the spindle motor 3.

When the tray 2 has been conveyed to the disc attachment position, the spindle motor 3 is moved upward by raising the motor base using a raising and lowering mechanism (not shown). The disc engagement portion 12a of the turntable 12 then engages the center hole 101b of the optical disc 101 so that the optical disc 101 is lifted by a predetermined distance from the disc holding portion 10. Also, by operating the raising and lowering mechanism in the opposite direction to lower the motor base, the disc engagement portion 12a of the turntable 12 is removed downward from the center hole 101b of the optical disc 101 so that the optical disc 101 is mounted onto the disc holding portion 10.

A chucking portion 14 is provided above the spindle motor 3. The chucking portion 14 presses the optical disc 101, which has been lifted by the raising and lowering mechanism of the spindle motor 3, from above. In this manner, the optical disc 101 becomes sandwiched between the chucking portion 14 and the turntable 12, thereby preventing the optical disc 101 from coming off the turntable 12.

The recording and/or reproducing unit 5 includes the optical pickup 16, a pickup base 17 on which the optical pickup 16 is mounted, and a pair of first guide shafts 18a, 18b that guide the pickup base 17 in the radial direction of the optical disc 101.

The optical pickup 16 includes a light detector, an objective lens, and a biaxial actuator that moves the objective lens close to the information recording surface of the optical disc 101. The light detector of the optical pickup 16 includes a semiconductor laser as a light source that emits a light beam and a light-receiving element that receives a return light beam. The optical pickup 16 focuses a light beam emitted from the semiconductor laser onto the information recording surface of the optical disc 101 using the objective lens and receives a return light beam that has been reflected by the information recording surface via the light detector. Accordingly, it is possible to write or read an information signal from or onto the information recording surface of the optical disc 101.

The optical pickup 16 is mounted on the pickup base 17 and moves with the pickup base 17. The two guide shafts 18a, 18b are disposed in parallel to the radial direction of the optical disc 101, which in the present embodiment is the direction in which the tray 2 moves, and are slidably inserted through the pickup base 17. In addition, the pickup base 17 can be moved along the two guide shafts 18a, 18b by a pickup moving mechanism including a pickup motor (not shown). When the pickup base 17 moves, an operation that records and/or reproduces an information signal on the information recording surface of the optical disc 101 is carried out using the optical pickup 16.

For example, it is possible to use a feed screw mechanism as the pickup moving mechanism that moves the pickup base 17. However, the pickup moving mechanism is not limited to a feed screw mechanism, and it is also possible to use a rack and pinion mechanism, a belt feed mechanism, a wire feed mechanism, or other type of mechanism.

The print unit 6 includes the print head 21, a pair of second guide shafts 22a, 22b, an ink cartridge 23, a head cap 24, a suction pump 25, a waste ink collection unit 26, and a blade 27.

The print head 21 is positioned opposite the label surface 101a of the optical disc 101. A plurality of ejection nozzles 31 that eject ink droplets are provided on a surface of the print head 21 that faces the label surface 101a. The plurality of ejection nozzles 31 are disposed in four rows that are aligned in the direction in which the print head 21 moves and are set so that ink droplets of a predetermined color are ejected in each row. In the present embodiment, ejection nozzles 31a for cyan (C), ejection nozzles 31b for magenta (M), ejection nozzles 31c for yellow (Y), and ejection nozzles 31d for black (K) are disposed in that order from the top in FIG. 1. Also, to remove thickened ink, bubbles, foreign matter, and the like from the ejection nozzles 31a to 31d, the print head 21 carries out a “dummy ejection” of ink before printing and after printing.

The two second guide shafts 22a, 22b that are parallel are slidably passed through the print head 21. The print head 21 is capable of being moved along the two second guide shafts 22a, 22b by a head moving mechanism including a head driving motor 32 (see FIG. 3). A guide shaft support member 33 that extends in a direction perpendicular to the direction in which the tray 2 moves is fixed to one end in the axial direction of each of the two second guide shafts 22a, 22b and the other ends of the second guide shafts 22a, 22b extend to the opposite side to the direction in which the tray 2 moves. The print head 21 is constructed so as to be withdrawn to a standby position on the outside in the radial direction of the optical disc 101 when printing is not being carried out.

The ink cartridge 23 is equipped with a cyan (C) ink cartridge 23a, a magenta (M) ink cartridge 23b, a yellow (Y) ink cartridge 23c, and a black (K) ink cartridge 23d corresponding to inks of the respective colors cyan (C), magenta (M), yellow (Y), and black (K). These ink cartridges 23a to 23d respectively supply ink to the ejection nozzles 31a to 31d of the print head 21.

The ink cartridges 23a to 23d each include a hollow vessel and store ink using the capillary action of a porous material enclosed inside the vessel. Connecting portions 35a to 35d are detachably connected to the openings of the ink cartridges 23a to 23d so that the ink cartridges 23a to 23d are connected to the ejection nozzles 31a to 31d of the print head 21 via the connecting portions 35a to 35d. This implies that when the ink inside a vessel has been used up, it is possible to easily detach the connection portion from the ink cartridge in question and replace the ink cartridge with a new ink cartridge.

The head cap 24 is provided at the standby position of the print head 21 and is attached to the surface of the print head 21 on which the plurality of ejection nozzles 31 are provided when the print head 21 has moved to the standby position. Accordingly, it is possible to prevent the ink included in the print head 21 from drying and to prevent dust, dirt, and the like from adhering to the respective ejection nozzles 31a to 31d. The head cap 24 includes a porous layer and temporarily stores ink that has been dummy ejected by the print head 21 from the respective ejection nozzles 31a to 31d. Thus, the internal pressure of the head cap 24 is adjusted by a valve mechanism (not shown), so as to be equal to atmospheric pressure.

The suction pump 25 is connected to the head cap 24 via a tube 36. When the head cap 24 is attached to the print head 21, the suction pump 25 applies a negative pressure to the internal space of the head cap 24. Accordingly, the ink inside the respective ejection nozzles 31a to 31d of the print head 21 and ink that has been dummy ejected by the print head 21 and temporarily stored in the head cap 24 are removed by suction. The waste ink collection unit 26 is connected to the suction pump 25 via a tube 37 and collects the ink that has been sucked out by the suction pump 25.

The blade 27 is disposed between the standby position and the print position of the print head 21. When the print head 21 moves between the standby position and the print position, the blade 27 contacts the respective front end surfaces of the ejection nozzles 31a to 31d and wipes away ink, dust, dirt, and the like that adhere to the front end surfaces. Note that by providing a moving mechanism that moves the blade 27 up and down, it is also possible to achieve a construction where it is possible to select whether the ejection nozzles 31a to 31d of the print head 21 are wiped.

FIG. 3 is a block diagram showing the flow of signals in the optical disc apparatus 1. The optical disc apparatus 1 includes the control unit 7, an interface unit 41, a recording control circuit 42, a tray driving circuit 43, a motor driving circuit 44, a signal processing unit 45, an ink ejection driving circuit 46, and a mechanism unit driving circuit 47.

The interface unit 41 is a connection unit for electrically connecting an external apparatus, such as a personal computer or a DVD recorder, to the optical disc apparatus 1. The interface unit 41 outputs signals supplied from the external apparatus to the control unit 7. Examples of such signals include a recording data signal corresponding to information to be recorded on the information recording surface of the optical disc 101 and an image data signal corresponding to visible information to be printed on the label surface 101a of the optical disc 101. The interface unit 41 also outputs a reproduction data signal read by the optical disc apparatus 1 from the information recording surface of the optical disc 101 to the external apparatus.

The control unit 7 includes a central control unit 51, a drive control unit 52, and a print control unit 53 that is a specific example of a “head control unit”. The central control unit 51 controls the drive control unit 52 and the print control unit 53. The central control unit 51 outputs a recording data signal supplied from the interface unit 41 to the drive control unit 52. The central control unit 51 also outputs an image data signal supplied from the interface unit 41 and a rotation angle signal supplied from the drive control unit 52 to the print control unit 53.

The drive control unit 52 controls rotation of the spindle motor 3 and the pickup driving motor (not shown) and controls recording of a recording data signal and reproduction of a reproduction data signal by the optical pickup 16. The drive control unit 52 outputs control signals for controlling rotation of the spindle motor 3, the pickup driving motor, and the tray driving motor to the motor driving circuit 44.

The drive control unit 52 also outputs control signals for controlling a tracking servo and a focus servo to the optical pickup 16 so that the light beam emitted from the optical pickup 16 follows a track on the optical disc 101. In addition, the drive control unit 52 outputs the rotation angle signal supplied from the signal processing unit 45 to the central control unit 51.

The recording control circuit 42 carries out an encoding process, modulation, and the like on a reproduction data signal supplied from the drive control unit 52 and outputs the processed reproduction data signal to the drive control unit 52. The tray driving circuit 43 drives the tray driving motor based on control signals supplied from the drive control unit 52. Accordingly, the disc tray 2 is conveyed into and out of the apparatus housing.

The motor driving circuit 44 drives the spindle motor 3 based on control signals supplied from the drive control unit 52. Accordingly, the optical disc 101 mounted on the turntable 12 of the spindle motor 3 is rotated. The motor driving circuit 44 also drives the pickup driving motor based on control signals from the drive control unit 52. Accordingly, the optical pickup 16 moves together with the pickup base 17 in the radial direction of the optical disc 101.

The signal processing unit 45 carries out demodulation, error detection, and the like on an RF (Radio Frequency) signal supplied from the optical pickup 16 to generate a reproduction data signal. The signal processing unit 45 also detects a rotation angle signal showing the rotation angle of the optical disc 101 based on the RF signal. The reproduction data signal and the rotation angle signal are outputted to the drive control unit 52.

The print control unit 53 controls the print unit 6 which includes the print head 21 and the head driving motor 32 to have printing carried out on the label surface 101a of the optical disc 101. The print control unit 53 generates ink ejection data based on the image data obtained according to an image data signal supplied from the central control unit 51. The generation of the ink ejection data is described in detail later in this specification. The print control unit 53 generates control signals that control the print unit 6 based on the generated ink ejection data and the rotation angle signal supplied from the central control unit 51 and outputs the control signals to the ink ejection driving circuit 46 and the mechanism unit driving circuit 47.

The ink ejection driving circuit 46 drives the print head 21 based on control signals supplied from the print control unit 53. As a result, ink droplets are ejected from the ejection nozzles 31 of the print head 21 and drip onto the label surface 101a of the optical disc 101 that is being rotated. The mechanism unit driving circuit 47 drives the head cap 24, the suction pump 25, the blade 28, and the head driving motor 32 based on control signals supplied from the print control unit 53. By driving the head driving motor 32, the print head 21 is moved in the radial direction of the optical disc 101.

The visible information is handled in the external apparatus as image data where tone values showing the luminance of the respective colors red (R), green (G), and blue (B) are expressed using biaxial perpendicular (X-Y) coordinates. Thus, the visible information is supplied to the central control unit 51 of the control unit 7 as the image data described above and is then inputted into the print control unit 53.

FIG. 4 is a flowchart showing a process with which the print control unit 53 generates the ink ejection data based on the image data. To generate the ink ejection data, first in step S1, image data expressed by tone values for the respective colors red (R), green (G), and blue (B) is converted into CYMK data expressed as distributions of dots (pixels) of the respective colors cyan (C), yellow (Y), magenta (M), and black (K). The dots that express this CYMK data have tone values that are based on the image data and in the present embodiment the tone values are in a range of 0 to 255, inclusive (i.e., 8-bit values).

Also, the CYMK data is divided into cyan data expressed by the distribution of cyan (C) dots, magenta data expressed by the distribution of magenta (B) dots, yellow data expressed by the distribution of yellow (Y) dots, and black data expressed by the distribution of black (K) dots. All of such data are transferred to the next step, but in the present embodiment cyan data is described below as a representative example.

Next, in step S2, the cyan data expressed by biaxial perpendicular coordinates is converted to polar (r-θ) coordinate data (the same applies to magenta data, yellow data, and black data). Thus, the resolution is converted using a common method such as nearest neighbor, bilinear, or high-cubic to produce polar coordinate data of a suitable size for the label surface 101a of the optical disc 101.

The conversion to polar coordinate data will now be described with reference to FIG. 5A to FIG. 5C. First, as shown in FIG. 5A, For example, visible information having a character string “ABCDEFGH” is inputted into the print control unit 53 as image data via the interface unit 41 and the central control unit 51. When the image data is inputted, as shown in FIG. 5B the print control unit 53 stores the character string “ABCDEFGH” as data in an X-Y coordinate system in a memory (not shown).

Next, as shown in FIG. 5C, the radius r from the center of rotation of the optical disc 101 and an angle θ expressed relative to an origin for measuring rotation angles are calculated for each dot (pixel) that composes the data expressed in the X-Y coordinate system. Accordingly, it is possible to convert the visible information from biaxial perpendicular (X-Y) coordinate data to polar (r-θ) coordinate data. Note that the calculations carried out for such conversion can be carried out using a common method such as nearest neighbor or linear interpolation.

Next, in step S3, dot density correction is carried out on the polar coordinate data to calculate dot correction data. “Dot density correction” refers to a calculation that applies a correction weighting to the tone value of each dot in the polar coordinate data. That is, dot density correction is a calculation that reduces the tone values of dots in accordance with how close the dots are to the inner periphery of the polar coordinate data.

The correction weighting used for the dot density correction is calculated based on the ratio of the number of dots per unit area centered on the dot to be weighted to the number of dots per unit area centered on a dot positioned in the outermost periphery of the polar coordinate data. In the present embodiment, an approximate calculation is carried out based on the ratio of the radius of the dot to be weighted to the radius of dots positioned in the outermost periphery of the polar coordinate data. That is, as shown in FIG. 6, if the radius of a dot dᵢ to be weighted is expressed as rᵢ and the radius of dots d_{N} positioned in the outermost periphery of the polar coordinate data is expressed as r_{N}, the weighting W(dᵢ) for the dot dᵢ is calculated by the following equation.
W(dᵢ)=rᵢ/r_{N}

For example, if the radius of the dot dᵢ is 30 mm and the radius of the dot d_{N} is 60 mm, the weighting W(dᵢ) for the dot dᵢ is 0.5.

If the correction weighting W for each dot is approximately calculated as described above, it is possible to use the same correction weighting for dots at the same radius and therefore possible to reduce the number of correction weightings to be stored in a memory. As a result, it is possible to reduce the capacity of the memory and to reduce the power consumed by the memory.

Next, in step S4, the dot correction data is binarized according to an error diffusion method to generate the ink ejection data. Note that the Floyd & Steinberg method and the Jarvis, Judice, & Ninke method can be given as examples of such error diffusion method. The ink ejection data is data that expresses whether ink droplets are to be ejected at each position corresponding to a dot on the label surface 101a of the optical disc 101. In the present embodiment, the tone values of the dots in the dot correction data are expressed as values from 0 to 255 (i.e., 8-bit values) and the tone values of the dots in the ink ejection data that has been binarized according to the error diffusion method are expressed using the values 0 and 255 (i.e., 1-bit values). Ink droplets are dripped onto positions on the label surface 101a corresponding to the dots of which tone values are 255 but are not dripped onto positions corresponding to the dots whose tone values are 0.

In the ink ejection data, dots show the positions where the ink droplets are dripped. By generating the ink ejection data by binarization according to an error diffusion method after the dot density correction has been carried out in step S3, it is possible to reduce the number of ink droplets to be ejected as the distance from the inner periphery of the label surface 101a falls.

The generation of the ink ejection data executed as described earlier will now be described with reference to FIGS. 7A to 7F and FIGS. 8A to 8J using specific numeric values. FIG. 7A shows dots A1 to A4 that are positioned at an outermost periphery of the polar coordinate data and have a radius value r_{N} of 60 mm and dots A5 to A8 that are positioned one line inside the dots A1 to A4 and have a radius value r_{N-1} of approximately 60 mm. The tone values of these dots A1 to A8 are all 255.

To generate ink ejection data from such polar coordinate data, first a correction weighting W is applied to each of the dots A1 to A8 of the polar coordinate data to calculate the dot correction data. Thus, the correction weighting W_{N-1}for the dots A1 to A4 is calculated as
W_{N}=r_{N}/r_{N}
r_{N}=60
so that the correction weighting W_{N} is 1.0. In the same manner, the correction weighting W_{N} for the dots A5 to A8 is calculated as
W_{N-1}=r_{N-1}/r_{N}
r_{N-1}=approximately 60
r_{N}=60
so that the correction weighting W_{N-1} is approximately 1.0. As a result, as shown in FIG. 7B, the tone values of the dots B1 to B8 of the dot correction data are all 255.

Next, Floyd & Steinberg error diffusion (with a threshold of 128) is carried out on the dots B1 to B8 of the dot correction data to binarize the data and generate ink ejection data like that shown in FIG. 7C. The error diffusion calculation will be described in detail later with reference to FIGS. 8A to 8J. As shown in FIG. 7C, the tone values of the dots C1 to C8 of the generated ink ejection data are all 255. As a result, ink droplets are dripped onto positions on the label surface 101a of the optical disc 101 that correspond to the dots C1 to C8 of the ink ejection data.

FIG. 7D shows dots D1 to D4 in the polar coordinate data that have a radius rᵢ of 30 mm and dots D5 to D8 that are positioned one line inside the dots D1 to D4 and have a radius rᵢ₋₁ of approximately 30 mm. The tone values of these dots D1 to D8 are all 255.

To generate ink ejection data from such polar coordinate data, first a correction weighting is applied to each of the dots D1 to D8 of the polar coordinate data to calculate the dot correction data. Thus, the correction weighting Wᵢ for the dots D1 to D4 is calculated as
Wᵢ=rᵢ/r_{N}
rᵢ=30
r_{N}=60
so that the correction weighting Wᵢ is 0.5. In the same manner, the correction weighting Wᵢ₋₁ for the dots D5 to D8 is calculated as
Wᵢ₋₁=rᵢ₋₁/r_{N}
rᵢ₋₁=approximately 30
r_{N}=60
so that the correction weighting Wᵢ₋₁ is approximately 0.5.

As a result, as shown in FIG. 7E, the tone values of the dots E1 to E8 of the dot correction data are all 127 (digits following a decimal point are discarded).

Next, Floyd & Steinberg error diffusion (with a threshold of 128) is carried out on the dots E1 to E8 of the dot correction data shown in FIG. 7E to binarize the data and generate ink ejection data like that shown in FIG. 7F. The error diffusion calculation will now be described in detail with reference to FIGS. 8A to 8J.

FIG. 8A shows error diffusion ratios used by Floyd & Steinberg error diffusion. FIG. 8B shows tone values of the dot correction data shown in FIG. 7E. FIG. 8J shows tone values of the ink ejection data shown in FIG. 7F. In addition, FIG. 8C to FIG. 8I show the calculation process for Floyd & Steinberg error diffusion when generating the ink ejection data shown in FIG. 8J from the dot correction data shown in FIG. 8B.

The error diffusion calculation carried out on the dot correction data described earlier can be carried out as follows, for example. First, the tone value of the dot F1 in the ink ejection data is calculated with the dot E1 in the dot correction data shown in FIG. 8B as a calculation point. This calculation sets the tone value of F1 at 0 if the tone value of the dot that is the calculation point is below the 128 threshold, or at 255 if the tone value is the 128 threshold or more. That is, since the tone value 127 of the dot E1 that is the calculation point is below the 128 threshold, the tone value of the dot F1 is set at 0 as shown in FIG. 8C.

Next, based on the error diffusion ratios shown in FIG. 8A, the tone values of the dots Ea2, Ea5, Ea6 shown in FIG. 8C are calculated. This calculation distributes the difference of 127 (=127−0) between the tone value 127 of the dot E1 that is the calculation point and the tone value 0 of the dot F1 among the tone values of the dots E2, E5, E6 based on the error diffusion ratios and sets the results as the tone values of the dots Ea2, Ea5, Ea6. That is, the tone values of the dots Ea2, Ea5, Ea6 are calculated according to the following equations
Ea2=E2+(E1−F1)×7/16
Ea5=E5+(E1−F1)×5/16
Ea6=E6+(E1−F1)×1/16
(where symbols such as E1, E2, Ea2 represent tone values).

For example, the tone value of the tone Ea2 is calculated as
127+(127−0)×7/16=182.

As a result, as shown in FIG. 8C, the tone value of the dot Ea2 is 182, the tone value of the dot Ea5 is 166, and the tone value of the dot Ea6 is 134. In addition, the tone values of the dots E3, E4, E7, E8 are transferred to the tone values of the dots Ea3, Ea4, Ea7, Ea8 to which no values are distributed based on the error diffusion ratios, resulting in all such values becoming 127.

Next, the tone value of the dot F2 in the ink ejection data is calculated with the dot Ea2 in the dot correction data shown in FIG. 8C as a calculation point. Since the tone value 182 of the dot Ea2 that is the calculation point is above the 128 threshold, the tone value of the dot F2 is set at 255 as shown in FIG. 8D.

Next, the difference of −73 (=182−255) between the tone value 182 of the dot Ea2 that is the calculation point and the tone value 255 of the dot F2 is distributed among the tone values of the dots Ea3, Ea5, Ea6, Ea7 based on the error diffusion ratios to calculate the tone values of the dots Eb3, Eb5, Eb6, Eb7 shown in FIG. 8D. That is, the tone values of the dots Eb3, Eb5, Eb6, Eb7 are calculated by the following equations
Eb3=Ea3+(Ea2−F2)×7/16
Eb5=Ea5+(Ea2−F2)×3/16
Eb6=Ea6+(Ea2−F2)×5/16
Eb7=Ea7+(Ea2−F2)×1/16
(where symbols such as Ea2, Eb3 represent tone values).

For example, the tone value of the tone Eb3 is calculated as
127+(182−255)×7/16=95.

As a result, as shown in FIG. 8D, the tone value of the dot Eb3 is 95, the tone value of the dot Eb5 is 152, the tone value of the dot Eb6 is 111, and the tone value of the dot Eb7 is 122. In addition, the tone values of the dots Ea4, Ea8 are transferred to the tone values of the dots Eb4, Eb8 to which no values are distributed based on the error diffusion ratios, resulting in both such values becoming 127.

Next, by carrying out calculation with the dot Eb3 as the calculation point, the tone value 0 of the dot F3, the tone value 168 of the dot Ec4, and the like are calculated as shown in FIG. 8E. The tone value 255 of the dot F4, the tone value 152 of the dot Ed5, and the like are then calculated as shown in FIG. 8F by carrying out calculation with the dot Ec4 as the calculation point. Subsequently, the tone value 255 of the dot F5, the tone value 82 of the dot Ee6, and the like are calculated as shown in FIG. 8G by carrying out calculation with the dot Ed5 as the calculation point.

The tone value 169 of the dot Ef7, and the like are then calculated as shown in FIG. 8H by carrying out calculation with the dot Ee6 as the calculation point, the tone value 0 of the dot F6. The tone value 255 of the dot F7, the tone value 66 of the dot Eg8, and the like are calculated as shown in FIG. 8I, by carrying out calculation with the dot Ef7 as the calculation point. After this, the tone value 0 of the dot F8 is calculated as shown in FIG. 8J by carrying out calculation with the dot Eg8 as the calculation point.

In this manner, by binarizing the dot correction data shown in FIG. 8B and FIG. 7E, the print control unit 53 can generate the ink ejection data shown in FIG. 8J and FIG. 7F. Next, it is possible to thin out (i.e., reduce) the number of ejected ink droplets by carrying out printing using such ink ejection data, while still corresponding to the visible information as the distance from the inner periphery of the label surface 101a falls and thereby possible to make the print density of the visible information printed on the label surface 101a substantially uniform.

As shown in FIG. 4, in step S5 the print control unit 53 divides the ink ejection data in accordance with the number of ejection nozzles 31 aligned in the radial direction of the optical disc 101. As shown in FIGS. 9A to 9C, in the present embodiment the ink ejection data is divided into three. That is, FIG. 9A is an image of first divided data T corresponding to the outer periphery of the print region, FIG. 9B is an image of second divided data U corresponding to a central periphery of the print region, and FIG. 9C is an image of third divided data V corresponding to the inner periphery of the print region. Note that the number of pieces into which the ink ejection data is divided may be set at two or below or at four or more in accordance with the number of ejection nozzles 31 aligned in the radial direction.

FIG. 10 is a diagram useful in explaining positions on the label surface 101a of the optical disc 101 corresponding to the dots in the first divided data T. The first divided data T is divided by the print control unit 53 into first revolution first divided data T1 that shows whether ink droplets should be ejected during a first revolution of the optical disc and second revolution first divided data T2 that shows whether ink droplets should be ejected during a second revolution of the optical disc at parts left by the first revolution.

FIG. 11A is a diagram useful in explaining positions on the label surface 101a of the optical disc 101 that correspond to dots in the first revolution first divided data T1. The first revolution first divided data T1 includes a plurality of dots d1 that are aligned in the radial direction of the optical disc 101 and are one position apart in the circumferential direction. During one revolution of the optical disc 101, the print control unit uses the first revolution first divided data T1 to control the dripping of ink droplets at a plurality of positions that are a predetermined interval apart in the circumferential direction.

Also, FIG. 11B is a diagram useful in explaining positions on the label surface 101a of the optical disc 101 that correspond to dots in the second revolution first divided data T2. The second revolution first divided data T2 includes a plurality of dots d2 that are aligned in the radial direction of the optical disc 101 and are disposed between the columns of dots in the first revolution first divided data T1. During another (i.e., a second) revolution of the optical disc 101, the print control unit 53 uses the second revolution first divided data T2 to control the dripping of ink droplets at the parts left by the first revolution.

Although not shown, in the same manner as the first divided data T, the second divided data U is divided into first revolution second divided data U1 and second revolution second divided data U2 and the third divided data V is divided into first revolution third divided data V1 and second revolution third divided data V2.

The printing of the visible information using the first to third divided data T, U, V described above can be carried out as follows for example. First, the print head 21 is moved to a position corresponding to the first divided data T. After this, ink droplets are ejected according to the first revolution first divided data T1 during one revolution of the optical disc 101. Accordingly, printing at positions corresponding to the plurality of dots d1 in the first revolution first divided data T1 shown in FIG. 11A is completed.

Next, during another revolution (the second revolution) of the optical disc 101, ink droplets are ejected according to the second revolution first divided data T2. Accordingly, printing at positions corresponding to the plurality of dots d2 in the second revolution first divided data T2 shown in FIG. 11B is completed. As a result, printing at positions corresponding to all dots in the first divided data T is completed.

Note that when the position of the last ink droplet dripped according to the first revolution first divided data T1 and the position of the first ink droplet dripped according to the second revolution first divided data T2 are close, there are cases where the dripping of ink droplets according to a predetermined ejection frequency will not be fast enough. In such cases, it is possible to shift the position of the first ink droplets dripped by the second revolution first divided data T2 and/or to provide an interval of one revolution.

Next, the print head 21 is moved to a position corresponding to the second divided data U. After this, during one revolution of the optical disc 101, ink droplets are ejected according to the first revolution second divided data U1 and during another (i.e., a second) revolution of the optical disc 101, ink droplets are ejected according to the second revolution second divided data U2. As a result, the printing at positions corresponding to all dots in the second divided data U is completed.

Next, the print head 21 is moved to a position corresponding to the third divided data V. After this, during one revolution of the optical disc 101, ink droplets are ejected according to the first revolution third divided data V1 and during another (i.e., a second) revolution of the optical disc 101, ink droplets are ejected according to the second revolution third divided data V2. Accordingly, the printing at positions corresponding to all dots in the third divided data V is completed, and as a result, it is possible to print the visible information on the label surface 101a of the optical disc 101.

As shown in FIG. 10, below are some cases demonstrating the following cases:

the distance r from the center of the ink droplets dripped onto the outermost periphery of the printable region according to the first divided data T to the center of rotation 0 of the optical disc 101 is 60 mm;

the interval L1 between ink droplets that are aligned in the outermost periphery for the case where ink droplets are dripped onto positions corresponding to all of the dots in the first divided data T is 42.3 μm (corresponding to 600 dpi); and

the ejection frequency of the ink droplets ejected from the print head 21 is 10 KHz.

As shown in FIG. 11A, the interval at which the dots are aligned in the outermost periphery of the first revolution first divided data T1 is the interval between every other dot in the outer circumference of the first divided data T (the same applies for the second revolution first divided data T2). This implies that the interval L2 between ink droplets dripped onto the outermost periphery of the printable region according to the first revolution first divided data T1 is 84.6 μm (corresponding to 300 dpi). Accordingly, the number of revolutions per minute (i.e., rpm) of the optical disc 101 is calculated as shown below.
linear speed: 84.6 μm[m]×10×10³ [1/s]=0.846 [m/s]
disc rotation speed: 0.846 [m/s]/(120×10⁻³×π)×60 [s]=134.6 [rpm]

In this manner, by dividing the first divided data T into the first revolution first divided data T1 and the second revolution first divided data T2, it is possible to set the number of revolutions per minute (i.e., rpm) of the optical disc 101 at 134.6 rpm. That is, it is possible to raise the number of revolutions per minute (i.e., rpm) of the spindle motor 3 above 100 rpm. As a result, it is possible to cause the spindle motor 3 to rotate stably so that favorable print quality can be obtained.

Although a construction where the divided data T, U, V are respectively divided into first revolution divided data second revolution divided data is used in the present embodiment, the present invention is not limited to this. That is, the divided data T, U, V may be respectively divided into a plurality of data having first revolution is data that shows where ink droplets are to be ejected during a first revolution of the optical disc and second and subsequent data that show whether ink droplets are to be ejected during a second and subsequent revolutions of the optical disc onto parts left by the first revolution. Thus, the data after division (for example, the first revolution first divided data T1 and the second revolution first divided data T2 of the above embodiment) are each having a plurality of dots out of the dots aligned in the circumferential direction of the data before division (in this example, the first divided data T of the above embodiment) that are spaced at least one dot apart.

FIG. 12 is a diagram useful in explaining first revolution first divided data Ta1 that is a second specific example of the first revolution first divided data. As shown in FIG. 12, this first revolution first divided data Ta1 includes a plurality of dots da1 that are disposed at intervals of one dot in the circumferential direction of the optical disc 101 and also at intervals of one dot in the radial direction so as to form an overall staggered pattern. The print control unit 53 carries out control by using this first revolution first divided data Ta1, so that the ejection timing at which ink droplets are ejected differs for the respective nozzles out of the plurality of ejection nozzles 31 on the print head 21.

In the same manner as with the first revolution first divided data T1, the intervals between the dots aligned in the circumferential direction in the first revolution first divided data Ta1 are the intervals between every other dot aligned in the circumferential direction in the first divided data T. This implies that in the same manner as with the first revolution first divided data T1, the number of revolutions per minute (i.e., rpm) of the spindle motor 3 can be set higher than 100 rpm. As a result, the spindle motor 3 can rotate stably and favorable print quality can be obtained.

As described above, according to the embodiments of the present invention, since the head control unit carries out control so that ink droplets are applied to a plurality of positions at predetermined intervals in the circumferential direction during a first revolution of a rotating disc-shaped recording medium and ink droplets are applied during second and subsequent revolutions onto parts left by the first revolution, it is possible to carry out printing by ejecting ink droplets with a predetermined ejection frequency while stably rotating the disc-shaped recording medium.

The present invention is not limited to the embodiments described above and shown in the drawings and can be subjected to a variety of modifications without departing from the scope of the invention. For example, although an example where a DVD-RW is used as the recording medium has been described in the above embodiments, it is possible to apply the present invention to a print apparatus that uses a recording medium of another recording method that utilizes a magneto-optical disc, a magnetic disc, or the like. In addition, a print apparatus according to an embodiment of the present invention is not limited to the disc recording/reproducing apparatus described above and it is possible to apply the present invention to a disc drive apparatus, an image pickup apparatus, a personal computer, an electronic dictionary, a DVD player, a car navigation system, or another type of electronic appliance that can use this type of print apparatus.

It should be understood by those skilled in the art that various modifications, combinations, sub-combinations, and alterations may occur depending on design requirements and other factors insofar as they are within the scope of the appended claims or the equivalents thereof.

What is claimed is:

1. A print apparatus comprising:
a disc rotating unit that rotates a disc-shaped recording medium detachably mounted thereon;
an optical pickup that carries out recording and/or reproduction of an information signal on an information recording surface of the disc-shaped recording medium rotated by the disc rotating unit;
a print head that prints visible information by ejecting ink droplets onto a label surface of the rotated disc-shaped recording medium; and
a head control unit that controls ejection timing of the ink droplets ejected by ejection nozzles provided on the print head, wherein
the head control unit carries out control so that a part of the visible information to be printed that corresponds to one revolution of the disc-shaped recording medium is printed by applying ink droplets at a plurality of positions a predetermined interval apart in a circumferential direction during a first revolution of the disc-shaped recording medium and applying ink droplets to a part left by the first revolution during at least a second revolution.

2. A print apparatus according to claim 1, wherein
the print head includes a plurality of ejection nozzles aligned in the radial direction of the disc-shaped recording medium, and
the head control unit carries out control so that the ink droplets are ejected from the plurality of ejection nozzles at the same ejection timings.

3. A print apparatus according to claim 1, wherein
the print head includes a plurality of ejection nozzles aligned in the radial direction of the disc-shaped recording medium, and
the head control unit carries out control so that the ink droplets are ejected from respective ejection nozzles in the plurality of ejection nozzles at different ejection timings during the first revolution of the disc-shaped recording medium.

4. A print apparatus according to claim 1, wherein
the print head includes a plurality of ejection nozzles aligned in the radial direction of the disc-shaped recording medium, and
the head control unit carries out control so that the ink droplets to be ejected are thinned in accordance with a distance in the radial direction of the disc-shaped recording medium.

5. A method of printing visible information by ejecting ink droplets from a print head onto a label surface of a disc-shaped recording medium rotated by a disc rotating unit, the method comprising:
a first ejecting step of printing a part of the visible information to be printed that corresponds to one revolution of the disc-shaped recording medium by ejecting ink droplets at a plurality of positions a predetermined interval apart during a first revolution of the disc-shaped recording medium; and
a second ejecting step of applying ink droplets onto a part left by the first revolution during at least a second revolution.
